(19) United States
(12) Patent Application Publication
(10) Pub. No.: US 2015/0121218 A1
(43) Pub. Date: Apr. 30, 2015

(54) METHOD AND APPARATUS FOR CONTROLLING TEXT INPUT IN ELECTRONIC DEVICE

(71) Applicant: Samsung Electronics Co., Ltd., Gyeonggi-do (KR)

(72) Inventors: Sungjun KIM, Daegu (KR); Minho KIM, Gyeongsangbuk-do (KR); Jisook KANG, Daegu (KR); Jinwan AN, Daegu (KR)

(73) Assignee: Samsung Electronics Co., Ltd.

(21) Appl. No.: 14/528,654

(22) Filed: Oct. 30, 2014

(30) Foreign Application Priority Data
Oct. 30, 2013 (KR) 10-2013-0130573

(51) Int. Cl. G06F 9/44; G06F 17/24; G06F 3/0481

(52) U.S. Cl. CPC G06F 9/4446; G06F 3/0481; G06F 17/24
USPC 715/708

(57) ABSTRACT

A method and apparatus for controlling a text input in an electronic device having a touch screen are provided. The method includes displaying at least one text inputted via a touch panel of the touch screen; when a deletion event is detected through the touch panel, deleting at least one of the displayed at least one text and storing the deleted at least one text in a memory unit; when the deletion event is removed, displaying a recovery guide on the touch screen and displaying the stored at least one text in the recovery guide; and when a selecting event is detected from the recovery guide, recovering at least one text selected from the recovery guide and displaying the selected at least one text as inputted at least one text.

### PRIORITY

This application claims priority under 35 U.S.C. §119(a) to a Korean Patent Application filed on Oct. 30, 2013 in the Korean Intellectual Property Office and assigned Serial No. 10-2013-0130573, the entire contents of which are incorporated herein by reference.

### BACKGROUND

1. Field of the Invention

The present invention relates generally to a method and apparatus for controlling a text input in an electronic device, and more particularly, to a method and apparatus for recovering text selected from a recovery guide and displaying the selected text as inputted text.

2. Description of the Related Art

With a remarkable growth of mobile communication technologies, electronic devices today are offered in various forms such as a smart phone, a wearable device, a tablet Personal Computer (PC), and the like. These electronic devices are popular due to their small size, which makes them portable, as well as their communication functions. Additionally, electronic devices having a touch screen are dramatically growing, aided by hardware and software for providing various contents.

To support portability, most electronic devices having a touch screen are equipped with either size-reduced, minimum physical keys or offer soft keys in the form of a virtual keypad represented on the touch screen. Therefore, an electronic device having a virtual keypad detects an input, or deletion, of characters through the virtual keypad and then performs a corresponding function. For example, a user who desires to correct a typing error during the input of characters presses a delete key in a typical virtual keypad to delete an erroneous character. If an erroneous character is in the middle of an already entered sentence, a user moves a cursor to the erroneous character and then presses the delete key. In this case, if a press of the delete key is detected for a predetermined time, the electronic device quickly deletes characters by words or sentences.

Deleting words, or sentences, via a long (i.e., sustained) press provides an advantage of quickly deleting numerous words at one time. This may often cause, however, any undesired deletion of correct characters. Alternatively, a user may quickly press the delete key several times so as to delete characters one by one. Sometimes this action may be recognized as a long press, thus resulting in any undesired deletion. If a correct character is deleted unintentionally, a user must reenter the character. This inconveniences a user.

### SUMMARY

The present invention has been made to address the above-mentioned problems and disadvantages, and to provide at least the advantages described below. Accordingly, an aspect of the present invention provides techniques to display deleted text in response to a user's input when correct text is deleted unintentionally.

In accordance with an aspect of the present invention, a method of controlling a text input in an electronic device having a touch screen is provided. The method includes displaying at least one text inputted via a touch panel of the touch screen; when a deletion event is detected through the touch panel, deleting at least one of the displayed at least one text and storing the deleted at least one text in a memory unit; when the deletion event is removed, displaying a recovery guide on the touch screen and displaying the stored at least one text in the recovery guide; and when a selecting event is detected from the recovery guide, recovering at least one text selected from the recovery guide and displaying the selected at least one text as the inputted at least one text. In accordance with another aspect of the present invention, an apparatus for controlling a text input in an electronic device having a touch screen is provided. The apparatus includes a display panel configured to display at least one text and a recovery guide for displaying a deleted at least one text; a touch panel configured to detect an input of the at least one text, a deletion event, and a selecting event for the recovery guide; a memory unit configured to store the deleted at least one text; and a control unit configured to: when the deletion event is detected via the touch panel, delete at least one of the displayed at least one text and store the deleted at least one text in the memory unit; when the deletion event is removed, control the display panel to display the recovery guide and the stored at least one text in the recovery guide; and when the selecting event is detected from the recovery guide, recover at least one text selected from the recovery guide and display the selected at least one text as inputted at least one text.

### BRIEF DESCRIPTION OF THE DRAWINGS

The foregoing and other aspects, features, and advantages of the present invention will be more apparent from the following description, taken in conjunction with the accompanying drawings, in which:

FIG. 1 is a block diagram illustrating an electronic device in accordance with an embodiment of the present invention;

FIG. 2 is a flowchart illustrating a method of recovering a deleted text in an electronic device in accordance with an embodiment of the present invention;

FIGS. 3A and 3B constitute a flowchart illustrating a method of recovering, based on a touch or drag, a text deleted by a press for a predetermined time in an electronic device in accordance with an embodiment of the present invention; and

FIGS. 4A to 4I are screenshots illustrating the recovery of deleted text in an electronic device in accordance with an embodiment of the present invention.

### DETAILED DESCRIPTION OF EMBODIMENTS OF THE PRESENT INVENTION

The following description with reference to the accompanying drawings is provided to assist in a comprehensive understanding of various embodiments of the present invention as defined by the claims and their equivalents. It includes details to assist in that understanding but these are to be regarded as merely exemplary. Accordingly, those of ordinary skill in the art will recognize that various changes and modifications of the embodiments described herein can be made without departing from the spirit and scope of the present invention. In addition, descriptions of well-known functions and constructions are omitted for clarity and conciseness.

The terms and words used in the following description and claims are not limited to their dictionary meanings, but, are merely used to enable a clear and consistent understanding of the present invention. Accordingly, it should be apparent to those skilled in the art that the following description of various embodiments of the present invention is provided for illustration purpose only and not for the purpose of limiting the present invention as defined by the appended claims and their equivalents.

It is to be understood that the singular forms “a,” “an,” and “the” include plural referents unless the context clearly dictates otherwise. Thus, for example, reference to “a text” includes reference to one or more of such texts.

It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the present invention, an electronic device displays on a screen a text inputted by a user. In the following description, the term “text” will be interpreted as including a character, a number, a symbol, an image, an emoticon, an icon, etc. which are editable and entered by a user.

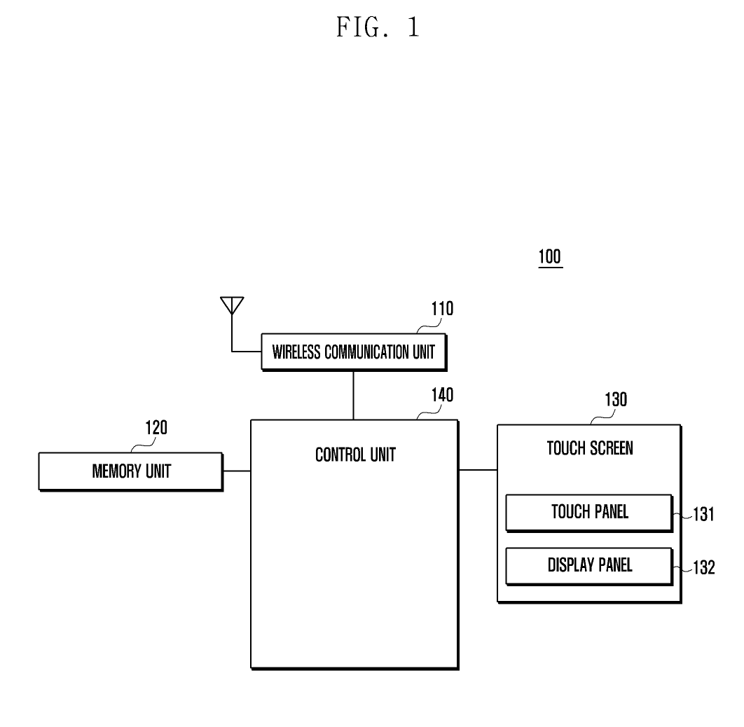

FIG. 1 is a block diagram illustrating an electronic device in accordance with an embodiment of the present invention.

Referring to FIG. 1, the electronic device 100 is configured to include a wireless communication unit 110, a memory unit 120, a touch screen 130, and a control unit 140. These elements of the electronic device 100, shown in FIG. 1, are not always essential. Alternatively, more or less elements may be included in the electronic device 100. For example, if the electronic device 100 does not support a communication function, then the wireless communication unit 110 is omitted.

The wireless communication unit 110 may have one or more modules capable of performing a wireless communication between the electronic device 100 and a wireless communication system or between the electronic device 100 and any other electronic device. For example, the wireless communication unit 110 may be configured to have a mobile communication module, a Wireless Local Area Network (WLAN) module, a short-range communication module, a location calculating module, and a broadcast receiving module.

The memory unit 120 stores therein a program required for the electronic device 100. In addition, when plural texts are deleted, the memory unit 120 temporarily stores therein the deleted texts.

The touch screen 130 is configured to have a touch panel 131 and a display panel 132. The touch panel 131 detects an event of inputting or deleting a text and also detects an event of selecting a recovery guide to recover the deleted text. The touch panel 131 is a panel for detecting a user's finger touch and/or a panel for detecting an electronic pen touch. The display panel 132 may be a Liquid Crystal Display (LCD), Organic Light Emitting Diode (OLED), or the like.

The control unit 140 controls the overall operation of the electronic device 100. Specifically, the control unit 140 recognizes the input or deletion of a text. When a deletion event is detected, the control unit 140 checks whether the deletion event is an event for deleting a plurality of texts. An event for deleting texts (or an event for displaying deleted text in a recovery guide) may be, but is not limited to, a long press, a double touch, a touch, a pinch zoom, a tap, a drag, or the like. The long press may occur by inputting a press of the delete key for a predetermined time (hereinafter called “long press”). If a deletion event for deleting a plurality of texts is detected, the control unit 140 displays the deleted texts in the recovery guide. While the deleted texts are displayed in the recovery guide, the control unit 140 checks whether any text is inputted. If the input of a text is detected, the control unit 140 terminates the display of the recovery guide and, instead, controls the inputted text to be displayed in response to the input of the text. Meanwhile, if an event for selecting the recovery guide is detected during the display of the deleted text in the recovery guide, the control unit 140 recovers the deleted text.

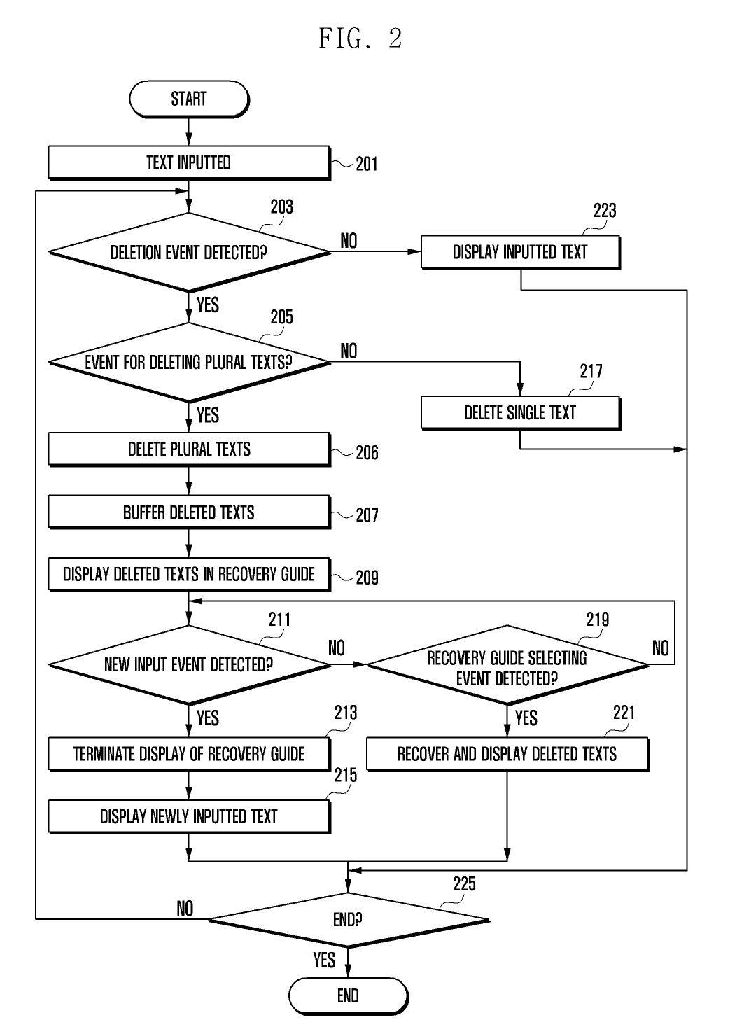

FIG. 2 is a flowchart illustrating a process of recovering a deleted text in an electronic device in accordance with an embodiment of the present invention.

Referring to FIGS. 1 and 2, in step 201, the control unit 140 detects the input of a text from the touch panel 131 and controls the display panel 132 to display thereon the inputted text. Input text includes a character, a number, a symbol, an image, an emoticon, an icon, etc. which is enterable and editable by a user with his or her finger or a pen. If a deletion event occurs while the inputted text is displayed, the control unit 140 detects the deletion event in step 203 and checks in step 205 whether the deletion event is an event for deleting plural texts. A deletion of plural texts may be to delete texts by words (i.e., in a unit of a word) or sentences (i.e., in a unit of a sentence). Also, an event for deleting plural texts may be a long (i.e., sustained) press, a double touch, a touch, a pinch zoom, a tap, a drag, or the like. If an event for deleting plural texts is not detected, the control unit 140 deletes a single text in step 217. Otherwise, if an event for deleting plural texts is detected, the control unit 140 detects this event in step 205 and deletes plural texts in step 206. Then, the control unit 140 temporarily stores (i.e., buffers) the deleted texts in the memory unit 120 in step 207 and displays the deleted texts in a recovery guide in step 209. If an input event for entering a new text occurs during the display of the recovery guide, the control unit 140 detects this new input event in step 211. Then, the control unit 140 terminates the display of the recovery guide in step 213 and displays the newly inputted text in step 215.

If a new input event is not detected while the recovery guide is displayed, the control unit 140 checks in step 219 whether the recovery guide is selected. If an event for selecting the recovery guide occurs, the control unit 140 in step 221 causes the deleted texts to be recovered and displayed. Then, if an event for ending a current text input process occurs in step 225 (e.g., the save key, the cancel key, or a like key is pressed), the text input process is ended. However, if no ending event occurs, the process returns to step 203. Namely, after any newly inputted text or recovered texts are displayed, the control unit 140 checks whether another deletion event occurs and whether this deletion event is intended to delete plural texts. If plural texts are deleted, the control unit 140 displays the deleted texts in a recovery guide. Then, when a further event for inputting a new text is detected, the control unit 140 removes the displayed recovery guide and displays the newly inputted text. Alternatively, if an event for selecting the recovery guide is detected, the control unit 140 recovers and displays the deleted texts. Therefore, even though plural texts are deleted, the deleted texts are displayed in the recovery guide, where they may be recovered at one time or selectively in response to a user's selection of the recovery guide.

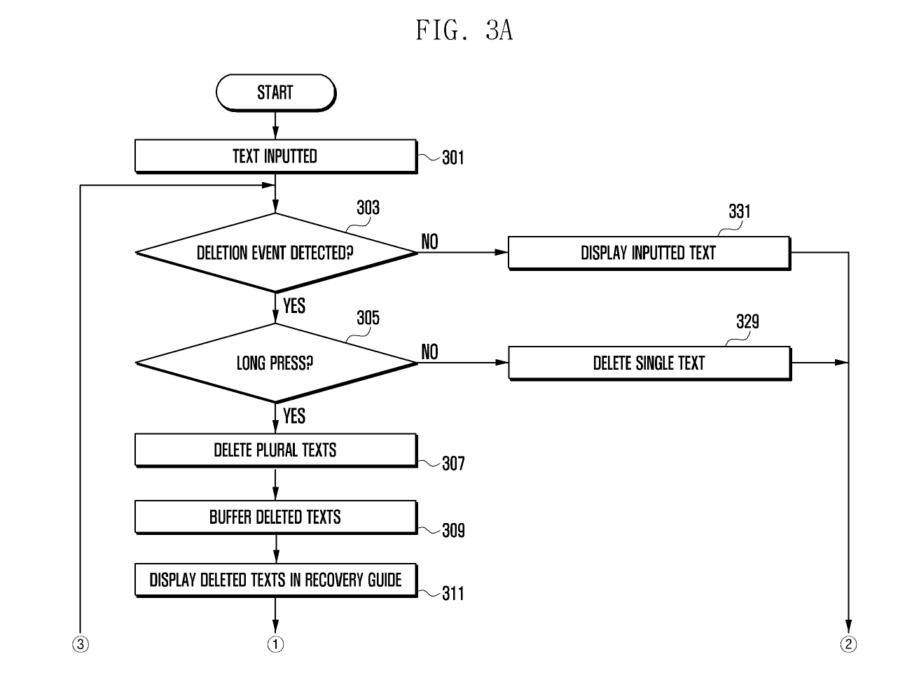

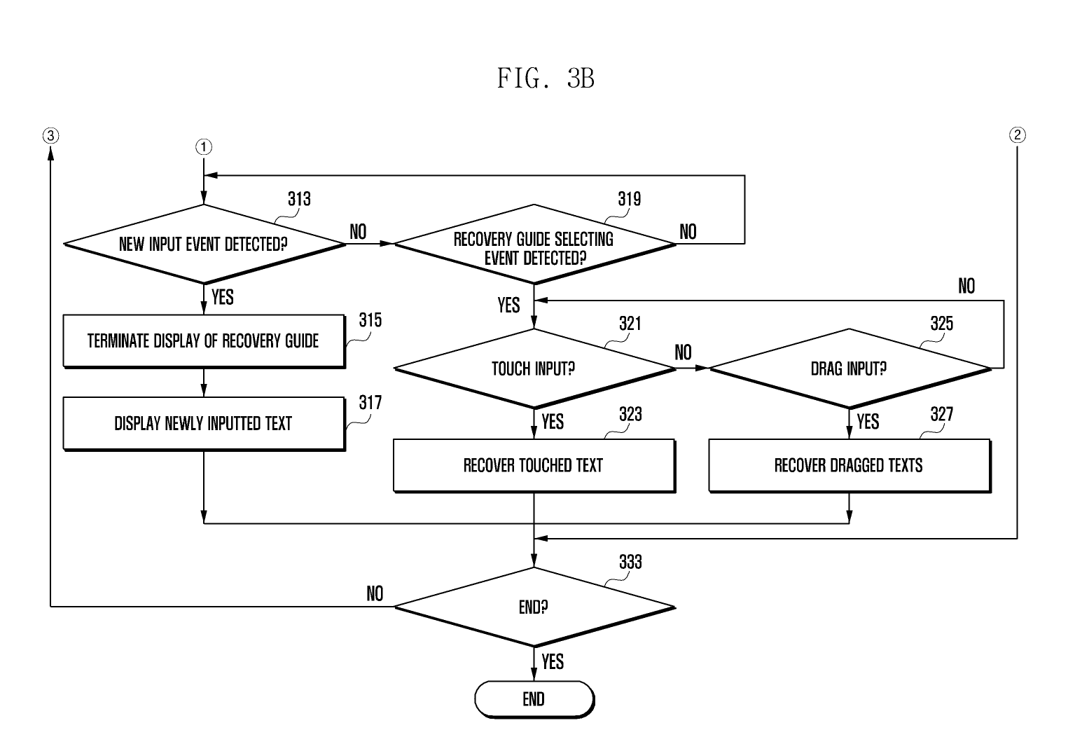

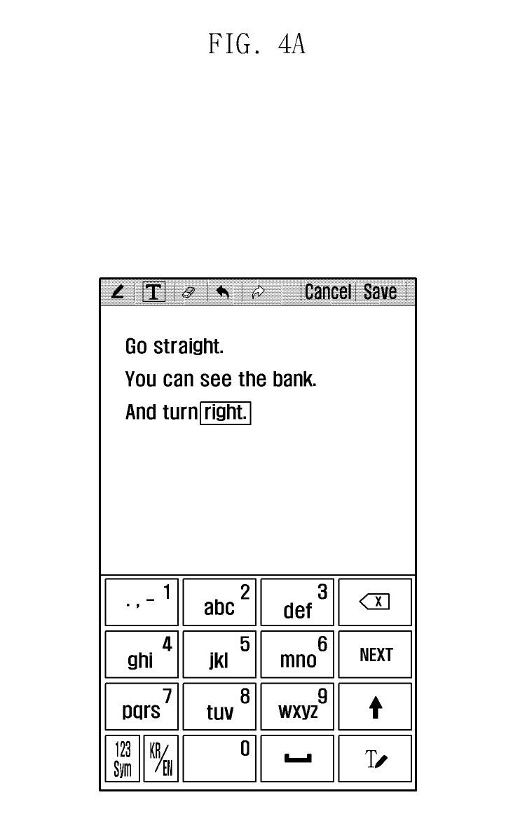

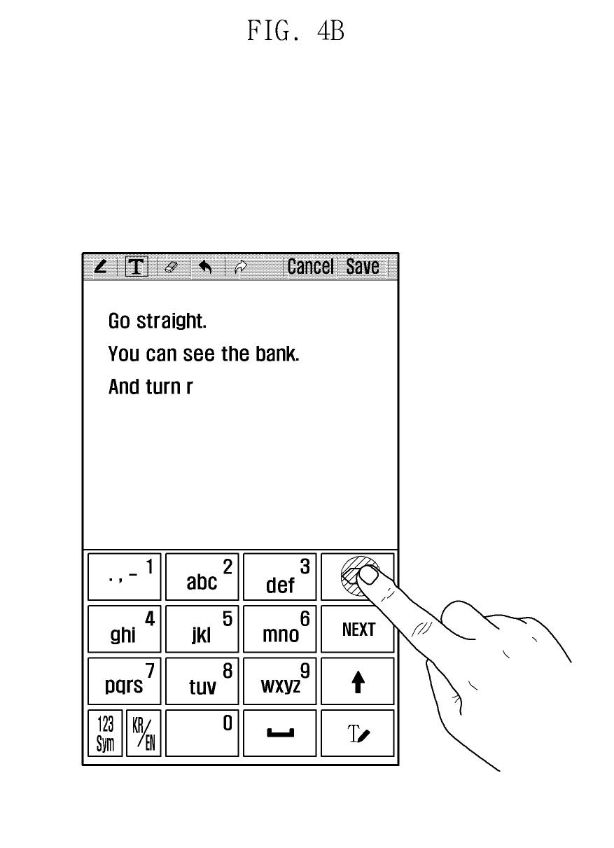

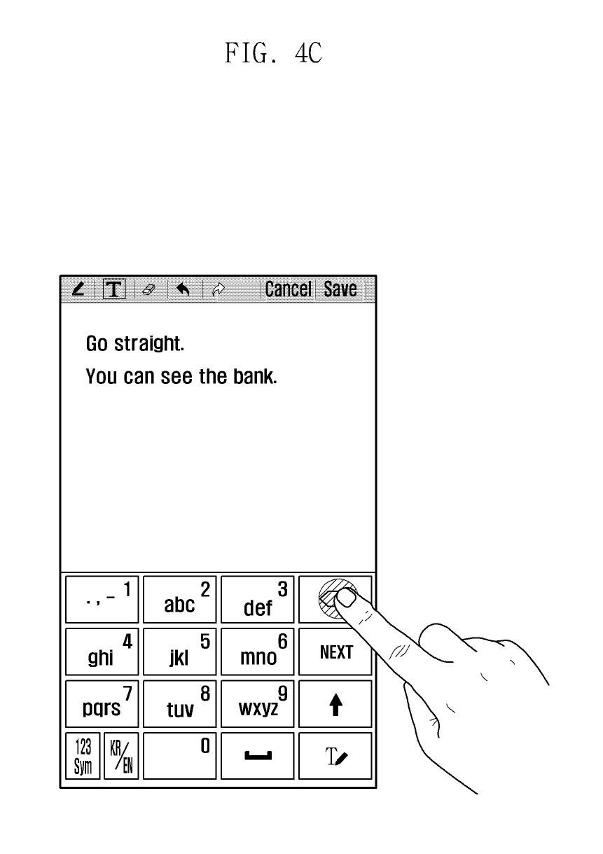

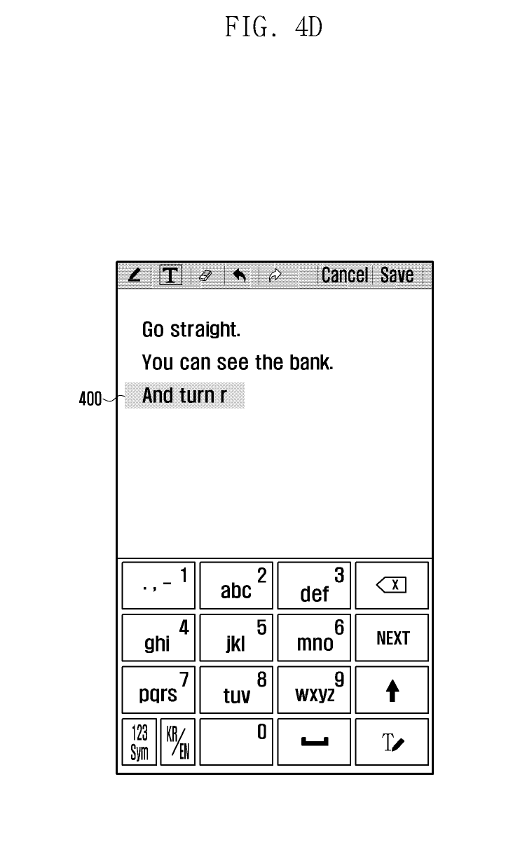

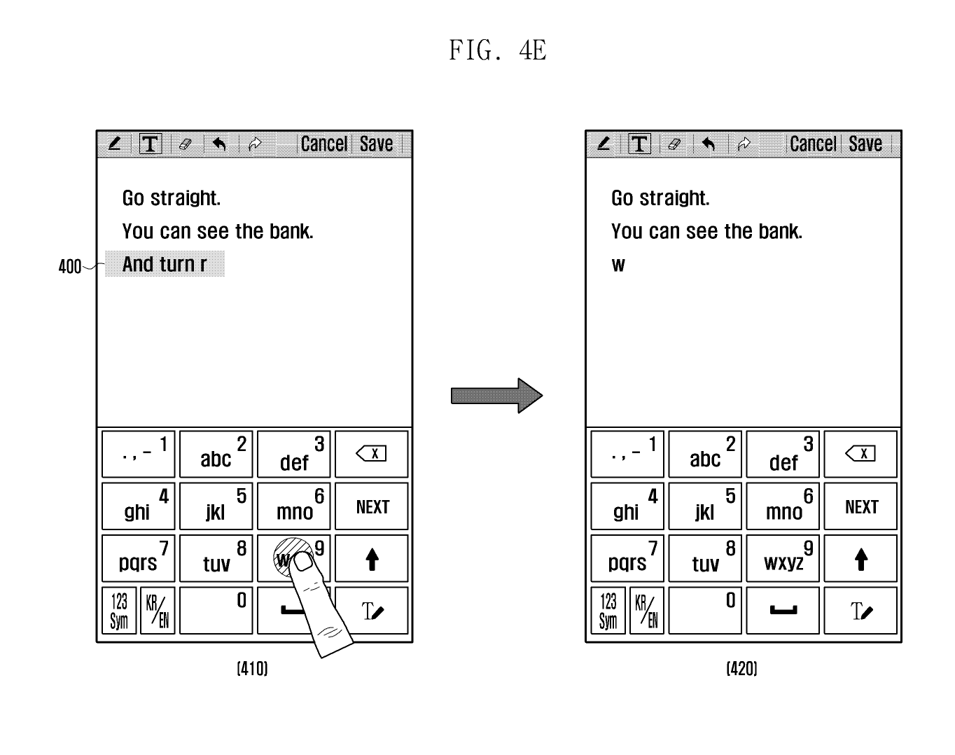

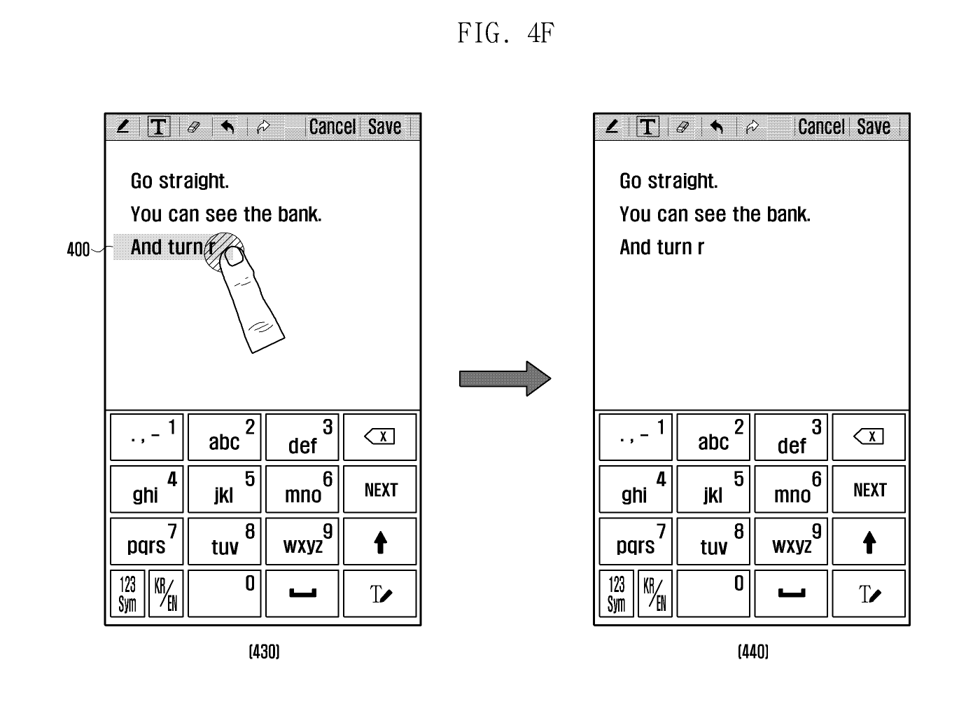

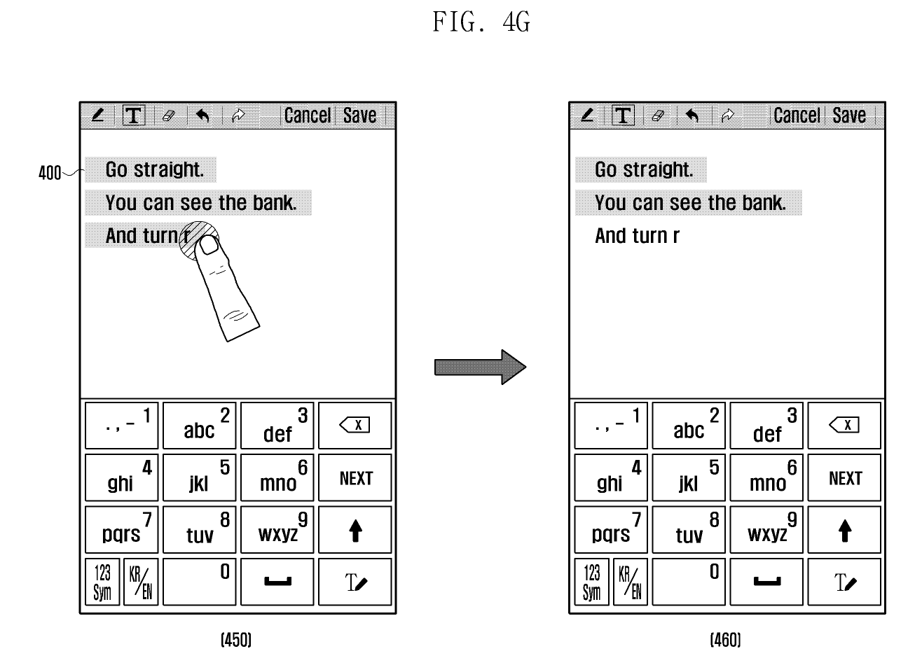

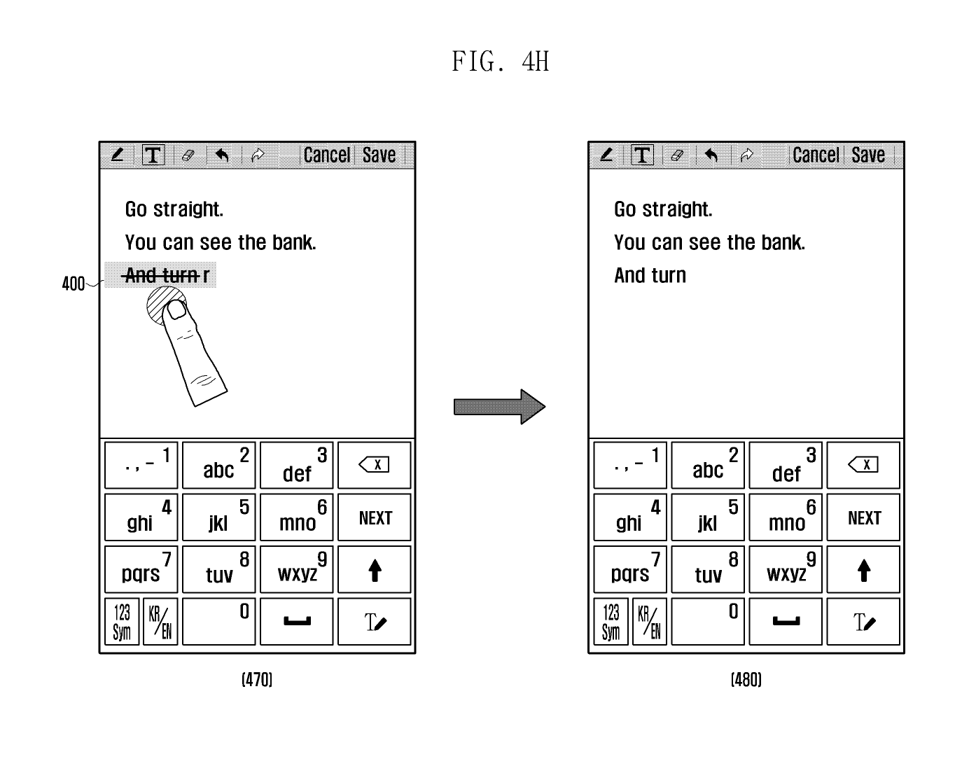

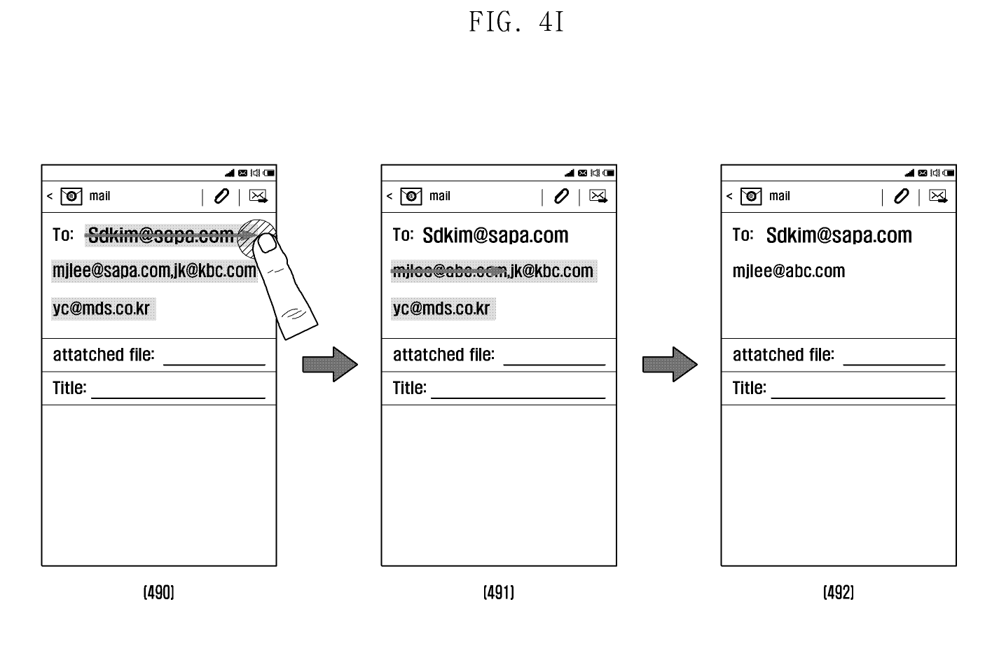

FIGS. 3A and 3B constitute a flowchart illustrating a method of recovery, based on a touch or drag, a text deleted by a long press in an electronic device in accordance with an embodiment of the present invention. FIGS. 4A to 4I are screenshots illustrating the recovering of deleted text in an electronic device in accordance with an embodiment of the present invention.

Referring to FIGS. 1, 3A, 3B, and 4A to 4I, in step 301 in FIG. 3A, the control unit 140 detects the input of a text from the touch panel 131 and controls the display panel 132 to display thereon the inputted text. If a deletion event occurs while the inputted text is displayed, as shown in FIG. 4A, the control unit 140 detects the deletion event in FIG. 3A in step 303 and checks in step 305 whether the deletion event is a long press. If the deletion event is not a long press, the control unit 140 deletes a single text in response to the deletion event in step 329. For example, FIG. 4B shows that four texts are deleted individually in response to the deletion event performed four times at the screen shown in FIG. 4A. If the deletion event is a long press, the control unit 140 deletes plural texts in FIG. 3A in step 307 while the long press is detected. Plural texts may be deleted by words (i.e., in a unit of a word) or sentences (i.e., in a unit of a sentence). For example, FIG. 4C shows that a long press is detected at the screen shown in FIG. 4B and, thereby, plural texts “r”, “turn”, and “And” are deleted continuously by words. Then the control unit 140 temporarily stores (i.e., buffers) the deleted texts “And turn r” in the memory unit 120 in FIG. 3A in step 309 and displays the deleted texts in a recovery guide 400 in step 311, as shown in FIG. 4D. If an input event for entering a new text is detected in FIG. 3B in step 313 during the display of the recovery guide 400, as shown in FIG. 4E in screenshot 410, the control unit 140 terminates the display of the recovery guide 400 in FIG. 3B in step 315 and displays the newly inputted text “w” in step 317, as shown in FIG. 4E in screenshot 420. In another embodiment, when a new input occurs, the control unit 140 may control the recovery guide 400 to remain being displayed.

If an event for selecting the recovery guide 400 occurs while the deleted texts are displayed in the recovery guide 400, the control unit 140 detects the recovery guide selecting event in FIG. 3B in step 319 and checks, in step 321, whether the recovery guide selecting event is a touch input. In this case, the touch input is considered an event for recovering the deleted texts at one time. Therefore, when a touch input is detected from the recovery guide 400, the control unit 140 recovers the deleted texts at the one time. If the deleted texts are in several lines, the control unit 140 may recover a single line of the deleted texts at one time through a touch input. This touch input may be, but is not limited to, a touch, a tap, a long press, a double touch, or the like. In FIG. 4F, screenshot 430 shows that a touch input occurs at the recovery guide 400 in which the deleted texts are displayed. If this touch input is detected, the control unit 140 recovers the deleted texts in FIG. 3B in step 323. Namely, when a touch input is detected at the recovery guide 400, the control unit 140 recovers, at one time, all texts “And turn r” displayed in the recovery guide 400, as shown in FIG. 4F in screenshot 440.

In another embodiment, texts displayed in the recover guide 400 are in several lines. If deleted texts of three lines “Go straight”, “You can see the bank”, and “And turn r” are displayed in the recovery guide 400, as shown in FIG. 4G in screenshot 450, the control unit 140 detects a touch input from the third line “And turn r” and then recovers the deleted texts “And turn r”. In this case, the first and second lines “Go straight” and “You can see the bank”, for which no touch input is detected, remain displayed in the recovery guide 400, as shown in FIG. 4G in screenshot 460.

While deleted texts are displayed in the recovery guide, the control unit 140 checks in FIG. 3B in step 325 whether the recovery guide selecting event is a drag input. In this case, the drag input is considered an event for selectively recovering the deleted texts in response to a user's selection. This drag input may be, but is not limited to, a drag, a drag and drop, a multi-touch, a multi-tap, a double touch, a double tap, a pinch zoom, or the like.

If a drag input is detected, as shown in FIG. 4H in screenshot 470, while the deleted texts are displayed in the recovery guide, in FIG. 3B in step 327, the control unit 140 selectively recovers only the dragged texts, as shown in FIG. 4H in screenshot 480. For example, when the plural texts “And turn r” are displayed in the recovering guide, the control unit 140 may detect a drag input from a part of the texts, i.e., “And turn”, as shown in screenshot 470. Then, the control unit 140 recovers and display only the dragged texts “And turn”, as shown in screenshot 480.

Additionally, if several lines of deleted texts are displayed in the recovery guide, as shown in FIG. 4I in screenshot 490, the control unit 140 may detect a drag input from the first line “sdkim@sapa.com”. Then, as shown in screenshot 491, the control unit 140 recovers only the dragged texts “sdkim@sapa.com” and continues to display the other texts, i.e., “mjlee@sapa.com”, “jk@kbc.com”, and “yc@mds.co.kr”, in the recovery guide. If an event for ending a current text input process occurs in FIG. 3B in step 333, the text input process is ended. However, if no ending event occurs, the process returns to FIG. 3A, step 303. Therefore, if a drag input is detected in the deleted texts “mjlee@sapa.com” while the recovery guide displays therein the deleted texts “mjlee@sapa.com”, “jk@kbc.com” and “yc@mds.co.kr” as shown in FIG. 4I in screenshot 491, the control unit 140 recovers and displays the dragged texts “mjlee@sapa.com”, as shown in a screenshot 492. In this case, if there is a non-dragged text in the line of the dragged text “mjlee@sapa.com”, the control unit 140 considers that there is no additional drag input, and terminates the display of the recovery guide as shown in screenshot 492.

As discussed hereinbefore, if a deletion event for deleting a text is detected while an inputted text is displayed, the control unit 140 performs a function to delete the text. If the deletion event is not a long press event, the control unit 140 deletes a single text. If the deletion event is a long press event, the control unit 140 deletes plural texts by units of words or sentences. In this case, the control unit 140 temporarily stores the deleted texts and displays them in the recovery guide 400. In the present disclosure, the recovering guide 400 may be represented as a box enclosed by a border, and the deleted texts displayed in the recovery guide 400 may be represented as a different font, a different font style (including italic, bold, and bold italic), a different size, a different font color, or any specific highlight effect (including strikethrough, shadow, outline, underline, dotted line) from that of undeleted text. If the input of a new text is detected while the deleted texts are displayed in the recovery guide 400, the control unit 140 displays the detected text. At the same time, the recovery guide 400 may be removed from the screen or continuously displayed on a part of the screen. If an event for selecting the recovery guide 400 is detected, the control unit 140 recovers and displays all, or a selection, of texts. For example, if the recovery guide selecting event is a touch input, all, or a selection, of a line of deleted texts may be recovered at one time. If the recovery guide selecting event is a drag input, only dragged texts are recovered.

In short, if plural texts are deleted at one time, the electronic device 100 temporarily displays the deleted texts in a recovery guide. Then, the electronic device 100 simultaneously, or selectively, recovers the deleted texts in response to a user's selection for the recovery guide. Therefore, the electronic device 100 allows a user to simply and exactly recover unintentionally deleted texts.

While the present invention has been particularly shown and described with reference to an exemplary embodiment thereof, it will be understood by those skilled in the art that various changes in form and details may be made therein without departing from the spirit and scope of the present invention as defined by the appended claims and their equivalents.

What is claimed is:

1. A method of controlling a text input in an electronic device having a touch screen, the method comprising:
displaying at least one text inputted via a touch panel of the touch screen;
when a deletion event is detected via the touch panel, deleting at least one of the displayed at least one text and storing the deleted at least one text in a memory unit;
when the deletion event is removed, displaying a recovery guide on the touch screen and displaying the stored at least one text in the recovery guide; and
when a selecting event is detected from the recovery guide, recovering at least one text selected from the recovery guide and displaying the selected at least one text as inputted at least one text.

2. The method of claim 1, wherein the deletion event includes an event for deleting at least one text by inputting a press to a delete key for a predetermined time via the touch panel.

3. The method of claim 1, wherein the deleted at least one text displayed in the recovery guide is represented as a different font, a different font style, a different size, and a different font color from that of the at least one text inputted, or a highlight effect.

4. The method of claim 1, wherein the selecting event detected from the recovery guide is a touch input, and wherein when the touch input is detected from the recovery guide, the deleted at least one text in the recovery guide is recovered at one time.

5. The method of claim 1, wherein the selecting event detected from the recovery guide is a drag input, and wherein when the drag input is detected from the recovery guide, a dragged at least one text from among the deleted at least one text in the recovery guide is recovered.

6. The method of claim 1, further comprising:
if an input of a another at least one text is detected from the touch panel while the recovery guide is displayed, terminating the displaying of the recovery guide and displaying the inputted another at least one text on the touch screen.

7. An apparatus for controlling a text input in an electronic device having a touch screen, the apparatus comprising:
a display panel configured to display at least one text and a recovery guide for displaying a deleted at least one text;
a touch panel configured to detect an input of the at least one text, a deletion event, and a selecting event for the recovery guide;
a memory unit configured to store the deleted at least one text; and
a control unit configured to:
when the deletion event is detected via the touch panel, delete at least one of the displayed at least one text and store the deleted at least one text in the memory unit;
when the deletion event is removed, control the display panel to display the recovery guide and the stored at least one text in the recovery guide; and
when the selecting event is detected from the recovery guide, recover at least one text selected from the recovery guide and display the selected at least one text as inputted at least one text.

8. The apparatus of claim 7, wherein the control unit is further configured to delete at least one text when the deletion event is detected by inputting a press to a delete key for a predetermined time via the touch panel.

9. The apparatus of claim 7, wherein when a touch input is detected as the selecting event from the recovery guide, the control unit is further configured to recover the deleted texts in the recovery guide at one time.

10. The apparatus of claim 7, wherein when a drag input is detected as the selecting event from the recovery guide, the control unit is further configured to recover a dragged at least one text from the deleted at least one text in the recovery guide.

11. The apparatus of claim 7, wherein the deleted at least one text displayed in the recovery guide is represented as a different font, a different font style, a different size, a different font color from that of the at least one text inputted, or a highlight effect.

12. The apparatus of claim 7, wherein the control unit is further configured to, when an input of another at least one text is detected from the touch panel while the recovery guide is displayed, control the display panel to terminate the displaying of the recovery guide and display the inputted another text.
